(19) United States
(12) Patent Application Publication
(10) Pub. No.: US 2026/0100002 A1
(43) Pub. Date: Apr. 9, 2026

(54) Filtering Augmented Display Content based on Validity Factors

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/910,398

(22) Filed: Oct. 9, 2024

(51) Int. Cl. G06T 19/00; G06V 10/764

(52) U.S. Cl. CPC G06T 19/006; G06V 10/764; G06V 2201/07

(57) ABSTRACT

Systems and methods are provided for filtering and/or blocking unreliable content that might normally be injected in an Augmented Reality (AR) or Virtual Reality (VR) device. In one implementation, a method includes a step of analyzing a scene obtained by an image capture device associated with an Augmented Reality (AR) system to detect one or more visible objects in the scene. The method also includes using identifying characteristics of the one or more visible objects to obtain content related to the one or more visible objects. Before presenting the content in an augmented content overlay with respect to the AR system, the method further includes filtering the content based on one or more trust or validity factors.

### FIELD OF THE DISCLOSURE

The present disclosure relates generally to Augmented Reality (AR) and Virtual Reality (VR) systems. More particularly, the present disclosure relates to systems and methods for checking security and validity in order to filter or screen augmented content so as to prevent unreliable content from being displayed in a “glass layer” of an AR/VR device.

### BACKGROUND

Augmented Reality (AR) and Virtual Reality (VR) (AR/VR) systems are not immune to hacking attempts and other malicious behavior. In the field of cybersecurity and content validation, security systems can be used to protect users by preventing the presentation of unreliable content (i.e., visual and/or audio content) on AR display screens and through speakers. Generative Artificial Intelligence (GenAI) can be created from various sources and GenAI information can be added to these AR/VR systems, which can be extremely helpful in many cases. However, a user of an AR/VR device can experience complications and even dangers when he or she is fed with invalid, outdated, malicious, and/or other types of inaccurate or deceptive data. With the introduction of new chatbots and GenAI systems, a new set of AI capabilities introduces a new set of risks. For example, when online information from various sources (e.g., chatbots, Large Language Models (LLMs), GenAI systems, etc.) are matched with AR/VR systems, an intermediate layer (or “augmented content overlay”) of the AR/VR device may interpose text, images, and audio for describing a scene or providing additional (augmented) information about the scene, streets, landmarks, historic data, etc. However, regulations are needed to ensure that the user is being fed with valid data and that malicious or inaccurate data is blocked, which would thereby ensure customer confidence and reduce or eliminate many dangerous situations.

### BRIEF SUMMARY

The present disclosure relates to systems and methods for providing a layer of security or trust layer with respect to Augmented Reality (AR) and/or Virtual Reality (VR) systems, particularly with respect to obtaining supplemental or augmented content that is intended to be inserted in a user's view interposed between the user's eyes and the real world. Instead of simply allowing the presentation of any information from the Internet, the systems and methods are configured to filter the content by determining whether or not the content is valid, authentic, etc. Also, valid information can be provided instead of unvalidated data or can replace this unvalidated data.

According to one implementation, a method for operating an AR/VR device includes the step of analyzing a scene obtained by an image capture device associated with an AR system to detect one or more visible objects in the scene. The method further includes a step of using identifying characteristics of the one or more visible objects to obtain content related to the one or more visible objects. Before presenting the content in an augmented content overlay with respect to the AR system, the method also includes filtering the content based on one or more trust or validity factors.

Furthermore, according to some embodiments, the step of filtering the content may include analyzing the one or more trust or validity factors to determine validity of the content with respect to verifiable content. The verifiable content may include, for example, information decoded from one or more valid steganographic images arranged on the one or more visible objects. In some embodiments, the method may further include a step of presenting the verifiable content in the augmented content overlay and discarding unverified content.

Also, in some implementations, the content may include Generative Artificial Intelligence (GenAI) obtained from one or more internal or external sources, wherein the content may initially be designated as having unknown validity and is considered to be unreliable until the one or more trust or validity factors are detected as indicating the validity of the content. The method, in some embodiments, may further include a step of presenting options to a user regarding the manner of presentation of the content designated as having unknown validity. For example, the method may also include a step of presenting the content designated as having unknown validity with a warning or caution that the content may be unreliable. The method may further include a) performing a source validation procedure to determine the validity of each of the one or more internal or external sources; and b) providing information in the augmented content overlay describing the validity of the one or more internal or external sources.

An action of detecting identifying characteristics may include real-time classification and identity functions performed by the AR system itself and/or a cloud-based server. The one or more visible objects, for example, may include street signs, traffic signals, road lane markings, pedestrian crossing signals, lamp posts, utility poles, vehicles, buildings, homes, grocery products, labels, logos, ads, banners, billboards, signs, QR codes associated with objects, bar codes associated with objects, and/or encoded steganographic images configured on specific objects.

In some embodiments, the identifying characteristics of the one or more visible objects may include size and shape information, operating status, vehicle make and model information, building address information, ingredient list, decoded optical character recognition information, decoded QR code or bar code information, decoded steganographic information, etc. The method may include presenting the content in the augmented content overlay in a manner that complies with applicable laws and regulations. The step of presenting the content in the augmented content overlay, for example, may be done in a manner intended to reassure a user of the AR system that the content has been filtered or screened for validity.

In various embodiments, the present disclosure may also include processing devices configured to implement the above-mentioned steps, cloud services configured to implement the above-mentioned steps, and/or non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIGS. 1A-1C are diagrams illustrating examples of various Augmented Reality (AR) and/or Virtual Reality (VR) devices worn in front of the user's eyes.

FIG. 2 is a diagram illustrating the visual field of a user of an AR/VR device in which an augmented layer is interposed between the user's eyes and images of the real world, according to various embodiments.

FIG. 3 is a diagram illustrating a user's viewpoint while wearing an AR device, wherein augmented content is overlaid in an augmented layer between the user's eyes and the real world, according to various embodiments.

FIG. 4 is a diagram illustrating a communication system in augmented content to be displayed on one or more AR and VR devices can be validated for authenticity, according to various embodiments.

FIG. 5 is a block diagram illustrating a computing system of an AR/VR device or trust entity for filtering augmented content to be overlaid in a glass layer, according to various embodiments.

FIG. 6 is a diagram illustrating a process of hiding an encoded image in a visible image using a steganographic technique, according to various embodiments.

FIG. 7 is a diagram illustrating an example of a QR code arranged on the outside surface of a vehicle used in ride-sharing or ride-hailing scenarios, according to various embodiments.

FIGS. 8A-8F are diagrams illustrating content displayed in an augmented content overlay of an AR/VR device, according to various embodiments.

FIG. 9 is a diagram illustrating a pedestrian crossing system where augmented content can be emphasized in a visual and/or auditory manner, particularly for the benefit of visually or hearing impaired, according to various embodiments.

FIG. 10 is a flow diagram illustrating a method for operating an AR/VR device, according to various embodiments.

FIG. 11 is a flow diagram illustrating another method for operating an AR/VR device, according to various embodiments.

### DETAILED DESCRIPTION

Again, the present disclosure relates to systems and methods for filtering, screening, and/or flagging virtual content until it can be validated as authentic or reliable. For example, the actions of filtering or screening may also include blocking or preventing unvalidated content from being displayed in an “artificial reality” system, such as Augmented Reality (AR) systems, Virtual Reality (VR) systems, mixed reality systems, and the like.

Artificial reality is a broad term that encompasses both AR and VR and generally refers to any computer-generated environment that simulates real or imaginary experiences. However, the term “artificial reality” is not a commonly used term. Instead, AR and VR are often the preferred terminology. AR adds to a user's real-world experience, while VR completely immerses the user in a digital one.

AR systems and devices is configured to overlay digital information (e.g., images, sounds, etc.) onto the real world and is configured to enhance a user's perception of reality rather than replacing it. Examples of AR devices may include dedicated AR systems, headsets, smart glasses, smart contact lenses, smart monocles, as well as mobile phones that use AR apps. In addition, other examples may include surgically implanted AR systems and other various devices. AR devices are configured to display navigation directions on a live camera feed or allow a user to play games (e.g., Pokémon GO), where virtual characters can appear in real-world settings.

VR systems and devices are configured to create a fully immersive digital environment that replaces the real world. Users typically wear headsets that block out their surroundings and provide a 3D experience, allowing them to interact with the virtual environment. VR is often used for gaming, training simulations, and virtual tours. Additionally, other technologies are possible including systems which can be used to describe content in the real world, e.g., for visually impaired users. The techniques described herein with reference to AR/VR can also apply herewith. That is, an AR/VR system described herein does not necessarily need to display content, but can also share details about content via audio, Braille, etc. The term AR/VR system is meant to encompass any technology use to observer the real world and provide descriptions based thereon.

In some embodiments of the present disclosure, certain objects (e.g., packaging for grocery products, road signs, vehicles, landmarks, etc.) may include coded information using any suitable form of encoding strategies (e.g., QR codes, bar codes, steganography, etc.). For example, the certain objects can be either manufactured or have some label affixed or included. Then, when the camera of an AR/VR device views the object (with the encoded information), the object and its corresponding verifiable information can be identified and validated as real. As a result, a user (or consumer) may have the confidence that the supplemental information or “augmented content overlay” (e.g., overlay, virtual content, digital overlay, augmented layer, highlighted digital information, glass layer, interposed layer, superimposed layer, etc.) is valid.

Otherwise, if any information is obtained via other means, such as by using a chatbot, GenAI model, etc., this information may originally be considered to be unreliable (e.g., intentionally or unintentionally wrong, fake, incorrect, misleading, false, inaccurate, errant, deceptive, tainted, malicious, nefarious, etc.) until it can be tested for validity. In some cases, the user may be given the option of viewing unvalidated information, but this information may be presented to the user with a warning of any suitable type (e.g., text in red, flashing text, a warning or caution statement, a disclaimer, etc.). In other situations, the user may wish to simply have any questionable content filtered out or discarded.

### Augmented Reality (AR) and Virtual Reality (VR) Examples

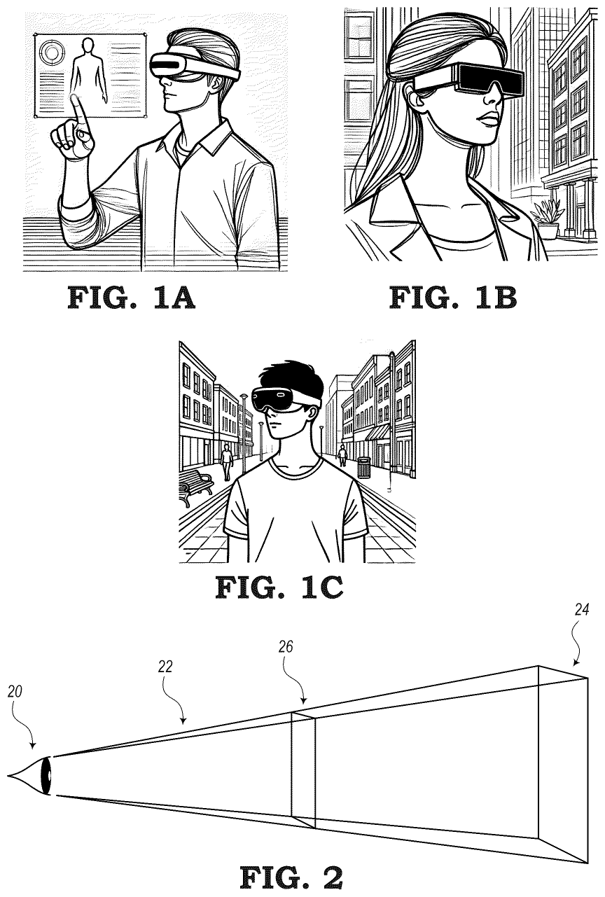

FIGS. 1A-1C are diagrams illustrating examples of various Augmented Reality (AR) and/or Virtual Reality (VR) devices worn on the user's face in front of their eyes. AR/VR devices can include visual components and/or audio components. For example, the visual components may include one or more cameras or image capture devices for observing the scenes where the user's eyes are directed. Other visual components include projection components (e.g., as shown in FIG. 1A) and/or display screens (e.g., head-up display, glass layer, augmented layer, etc., shown in FIGS. 1B-1C), which can be configured for visually presenting supplemental data to the user, such as text, images, etc. The audio components may include speakers, ear buds, earpieces, etc. for audibly providing content to the users.

FIG. 2 is a diagram illustrating an example of a user 20 of an AR/VR device (not shown). The user 20 typically has a field of view 22 that is generally in front of their eyes allowing them to see the world, depicted simply in planar form and defined as a view 24. However, with the use of an AR/VR device, an augmented content overlay 26 is placed intermediately, or as an interposed layer (e.g., glass layer) between the user 20 and the view 24 of the real world. As in the case of VR devices, the augmented content overlay 26 may be configured to fully replace the view 24 with virtual images so that the user 20 does not actually see the view 24. As in the case of AR devices, the augmented content overlay 26 may be configured to partially superimposed some text or images over the view 24 and is typically configured not to impede the user's view of the real world, but simply provide supplemental content that is intended to assist the user with additional information that can help to get directions, find purchasable products of interest, provide further details of objects within the user's view, etc.

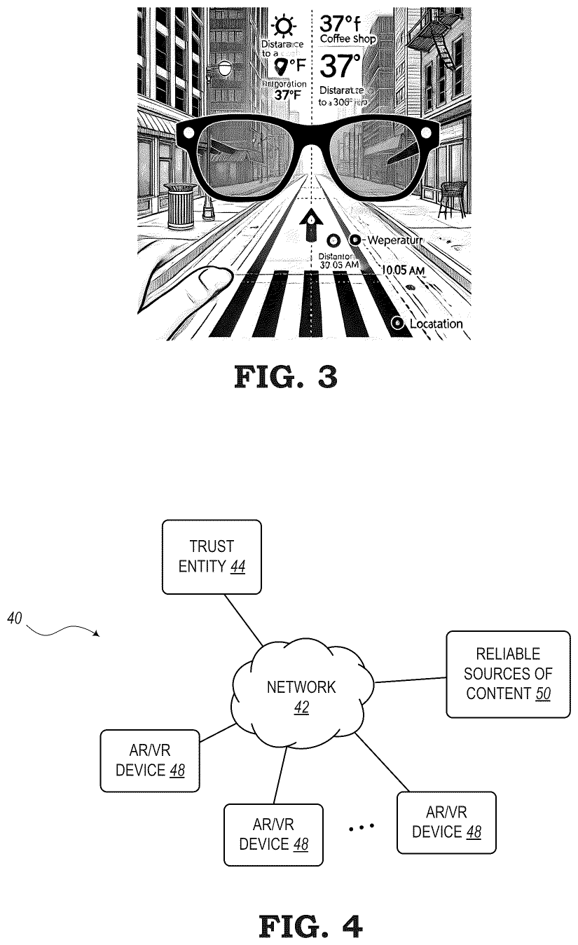

FIG. 3 is a diagram illustrating an example of a user's viewpoint while wearing an AR device, wherein augmented content is overlaid in an augmented layer (e.g., augmented content overlay 26) between the user's eyes and the real world. In this example, the augmented layer includes AR glasses having the ability to display information (e.g., directions, symbols, time, temperature, parking information, wheelchair accessibility information, shop location information, etc.).

In operation, AR and VR systems and devices are configured to gather supplemental data about the environment using a combination of sensors and software algorithms. For example, sensors may include cameras that capture real-time images of the environment, allowing the system to recognize surfaces, objects, and other elements. Depth sensors (e.g., LiDAR, stereo cameras, etc.) are configured to measure the distance to various objects, creating a 3D map of the surroundings. Also, inertial measurement devices and/or accelerometers are configured to track the device's orientation and movement, helping to stabilize and position virtual elements accurately.

Additionally, AR and VR systems and devices are configured to perform environmental mapping functions, such as Simultaneous Localization and Mapping (SLAM). Computing algorithms and techniques may help these devices to create a map of the environment while tracking its own position within that map. This can be used, for example, to accurately overlay digital content in AR views.

Furthermore, AR and VR systems and devices may include user input mechanisms. For example, users may be able to provide context through gestures, voice commands, or touch interactions, enhancing the system's understanding of what data to display. As shown in FIG. 1a, projection or hologram images may be presented in front of the user to receive user feedback.

Also, it may be noted that many AR and VR systems and devices can include many built-in features, such as software functionality allowing objects in the user's field of view to be identified, classified, etc. (e.g., object recognition). AR/VR devices can also use Artificial Intelligence (AI), which can analyze the collected data to improve object recognition, scene understanding, and contextual awareness, allowing for more dynamic interactions. By integrating these various data sources and technologies, AR/VR systems can create immersive experiences that enhance users'understanding and interaction with their environment.

In order to enable a greater experience, the AR/VR devices may be configured to connect wirelessly to communication systems and/or the Internet. In this way, information about the user's environment can be added from multiple sources. Some systems can access cloud-based databases for additional information about the environment. For example, a location-based AR app might pull data about historical landmarks or local points of interest. However, as suggested above, there is a possibility that false, inaccurate, malicious, misleading information may be introduced on the Internet. Also, malicious manufacturers (e.g., from adversarial countries) might program AR/VR devices to intentionally misdirect or misinform a user. Any type of misinformation, disinformation, fake/false information, deception, etc. may be introduced into the Internet or into specific AR/VR devices. This incorrect information may come from an intentionally misleading manufacturer, a hacker hijacking a user's device, intentional or unintentional incorrect information on the Internet, etc. Regardless of where the misleading information comes from (internally or externally) or who introduces the misleading information (e.g., malicious producer, adversarial country-state, hacker, etc.), the embodiments of the present disclosure are configured to test the validity of the information before it is provided to the user. Thus, the embodiments described herein act as a gateway, screen, filter, etc. for intercepting false information before it is provided to the user and causes distrust, confusion, and/or danger.

Also, with the introduction of newer versions of chatbots, LLMs, GenAI systems, etc., users are experiencing a new set of AI capabilities which are introducing new set of risks. For example, some LLMs can be matched with a camera of an AR device to determine what the user is seeing and may be capable of describing a scene. However, it should be noted that invalid information provided to certain individuals cannot be guaranteed as being secure, which can lead to dangerous situations. For example, consider a scenario where the user is a blind or visually impaired individual who relies on what an AR device is audibly describing. If the device says that the scene is an empty street with no cars, but in reality, it is actually a busy street, the user may experience considerable harm.

Again, misinformation may come from various malicious (or even benign) sources. For example, to alter information presented in an AR/VR device, a hacker might access a system or network on which the AR/VR is operating. This could involve exploiting vulnerabilities in software or gaining physical access to devices. Also, regarding content management, many AR and VR systems and applications might pull data from centralized servers or databases. If a hacker or other malicious entity is able to compromise these sources, they could potentially alter the information delivered to users.

Therefore, one goal of the embodiments of the present disclosure is to incorporate security measures that can prevent some forms of tampering as well as label/warn. By being aware of these potential security threats, the embodiments described herein are able to help detect and mitigate unauthorized changes or modification to AR/VR systems and block unvalidated information from being displayed to the user. Also, the systems and methods herein are configured to inform the users of questionable content so that the users can be cognizant of the possibility of information coming from an unreliable source and not trusting completely in any information that has yet to be validated or verified as legitimate. The education of users can help them recognize the value of knowing the difference between validated content and content that is either not yet validated or determined to be incorrect.

The embodiments include a set of security risk controls which can add a layer of identity to the depicted images in order to ensure the authenticity of the images for the user. Given that these images are in real life, the control will happen as part of the component within the VR camera and includes continued verification of the content vs real image while being presented to the user. The embodiments can therefore give users the confidence of what is real and to know with certainty what they are seeing is authentic or malicious.

### Communication System for Managing Augmented Content

FIG. 4 is a diagram illustrating an embodiment of a communication system 40 for managing augmented content with respect to AR and VR devices. As shown, the communication system 40 includes a network 42 (e.g., the Internet), a trust entity 44 (e.g., a Certificate Authority (CA), such as DigiCert), etc. The communication system 40 includes a plurality of AR/VR devices 48, such as those described with respect to FIGS. 1-3. The AR/VR devices 48 may include wired or wireless connection to the network 42, which may include access to one or more reliable sources of content 50. Thus, when the AR/VR devices 48 are operating, they can retrieve information and content from the communication system 40 for providing visual and auditory output to the user of the devices.

The AR/VR devices 48 and related systems can detect scenes having various objects and use cloud-based servers (e.g., trust entity 44) and/or other sources (e.g., the one or more reliable sources of content 50) to get additional information about those objects. Again, the AR/VR devices 48 can perform object recognition/detection and scene understanding using various sensors (e.g., cameras, depth sensors, LiDAR devices, infrared detectors, etc.) to capture real-time information from the environment. This raw data is used to detect the objects within the scene.

Also, once the data is captured, the AR/VR devices 48 can use computer vision algorithms to identify or classify objects. For example, it may recognize streets, vehicles, buildings, landmarks, people, stores, chairs, tables, etc. based on their shape, size, features, etc. However, even thought the individual AR/VR devices 48 may be capable of certain functions that are built into the devices, they can also utilize information and content gathered from external sources, such as the trust entity 44 or the one or more reliable sources of content 50. Cloud-based servers may be configured for bearing some of the object recognition and other data processing tasks. Thus, cloud connectivity via the network 42 allows the AR/VR devices 48 to receive assistance with detecting and identifying objects and scenes. Thus, the cloud-based servers can provide processing services and also provide augmented data accordingly. This allows the AR/VR devices 48 to offload computationally intensive tasks like image recognition, machine learning model inference, and/or data storage to cloud servers rather than relying solely on local hardware.

The cloud-based servers and sources can hold databases with object data, 3D models, or semantic information about the objects in the real world. The AR/VR devices 48 send objects'metadata (e.g., digital fingerprints based on visual features) to the servers, and, in return, the servers can respond with additional content or information, such as object identity (e.g., name or type of the object), additional metadata (e.g., information such as its function, historical background, or related media), and three-dimensional (3D) models or overlays (e.g., textual overlays, 3D graphics, labels, interactive elements, etc.) based on the objects and/or scenes.

Although many sources of information may be cloud-based, it should also be noted that edge computing servers may also be used for reducing latency and include local servers for providing real-time feedback for the users. The various servers and content sources, as well as the AR/VR devices 48 themselves, may use Machine Learning (ML) and AI-driven algorithms to allow the AR/VR devices 48 to recognize objects, scenes, and context in a dynamic environment. ML models may include neural networks and deep learning, which may be used for object classification and scene understanding.

### Computing System of AR/VR Devices and/or Trust Entity Servers

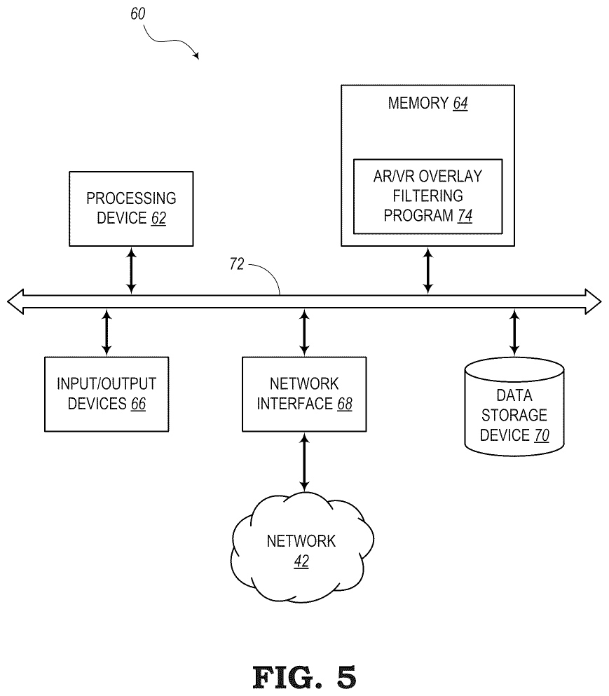

FIG. 5 is a block diagram illustrating an embodiment of a computing system 60 representing one or more of the AR/VR devices 48 and/or the trust entity 44 shown in FIG. 4. The computing system 60 may be configured for filtering augmented content that is intended to be overlaid in a glass layer. The computing system 60 may be a digital computer that, in terms of hardware architecture, generally includes a processing device 62, memory 64, input/output (I/O) devices 66, a network interface 68, and a data storage device 70. It should be appreciated by those of ordinary skill in the art that FIG. 5 depicts the computing system 60 in an oversimplified manner, and a practical embodiment may include additional components and suitably configured processing logic to support known or conventional operating features that are not described in detail herein. The components (62, 64, 66, 68, 70) are communicatively coupled via a local interface 72. The local interface 72 may be, for example, but not limited to, one or more buses or other wired or wireless connections, as is known in the art. The local interface 72 may have additional elements, which are omitted for simplicity, such as controllers, buffers (caches), drivers, repeaters, and receivers, among many others, to enable communications. Further, the local interface 72 may include address, control, and/or data connections to enable appropriate communications among the aforementioned components.

The processing device 62 is a hardware device for executing software instructions. The processing device 62 may be any custom made or commercially available processor, a Central Processing Unit (CPU), an auxiliary processor among several processors associated with the computing system 60, a semiconductor-based microprocessor (in the form of a microchip or chipset), or generally any device for executing software instructions. When the computing system 60 is in operation, the processing device 62 is configured to execute software stored within the memory 64, to communicate data to and from the memory 64, and to generally control operations of the computing system 60 pursuant to the software instructions. The I/O devices 66 may be used to receive user input from and/or for providing system output to one or more devices or components.

The network interface 68 may be used to enable the computing system 60 to communicate on a network, such as the Internet. The network interface 68 may include, for example, an Ethernet card or adapter or a Wireless Local Area Network (WLAN) card or adapter. The network interface 68 may include address, control, and/or data connections to enable appropriate communications on the network. A data storage device 70 (e.g., one or more databases, data stores, etc.) may be used to store data. The data storage device 70 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 70 may incorporate electronic, magnetic, optical, and/or other types of storage media. In one example, the data storage device 70 may be located internal to the computing system 60, such as, for example, an internal hard drive connected to the local interface 72 in the computing system 60. Additionally, in another embodiment, the data storage device 70 may be located external to the computing system 60 such as, for example, an external hard drive connected to the I/O devices 66 (e.g., SCSI or USB connection). In a further embodiment, the data storage device 70 may be connected to the computing system 60 through a network, such as, for example, a network-attached file server.

The memory 64 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 64 may incorporate electronic, magnetic, optical, and/or other types of storage media. Note that the memory 64 may have a distributed architecture, where various components are situated remotely from one another but can be accessed by the processing device 62. The software in memory 64 may include one or more software programs, each of which includes an ordered listing of executable instructions for implementing logical functions. The software in the memory 64 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 60 further includes an AR/VR overlay filtering program 74 that may be implemented in any suitable combination of hardware (e.g., configured in the processing device 62) and/or software/firmware (e.g., configured in the memory 64). The AR/VR overlay filtering program 74 may be stored in any suitable non-transitory computer-readable media (e.g., the memory 64) and may include computer logic or code having instructions that enable or cause the processing device 62 to perform certain actions as discussed in the present disclosure. In particular, the AR/VR overlay filtering program 74 may be configured to enable the processing device 62 to analyze content that is intended to be provided to the user as an overlay and determine if the content has been validated. If so, the content can be displayed in the glass overlay and/or audibly supplied to the speakers. If not, however, then the AR/VR overlay filtering program 74 may be configured to discard the content, ask the user if he or she wishes to receive the content, give a warning or caution while providing the content, and/or other various actions.

Of note, the general architecture of the computing system 60 can define any device described herein. However, the computing system 60 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

Therefore, the embodiments of the present disclosure may be implemented as a “trust layer” between an AR/VR device and the user and is configured to either block augmented content (e.g., text, images, etc.) or at least bring unvalidated content to the attention of the user in order that the user can decide how this content can be experienced. A goal may therefore be to avoid user deception.

The types of images or content may include, for instance, 1) created images (e.g., product labels, billboards, street signs, or other things that might be produced by humans), 2) known landmarks (e.g., buildings, historical sites, etc.), and 3) moving objects (e.g., trucks, cars, bicycles, people, etc.).

### Steganography

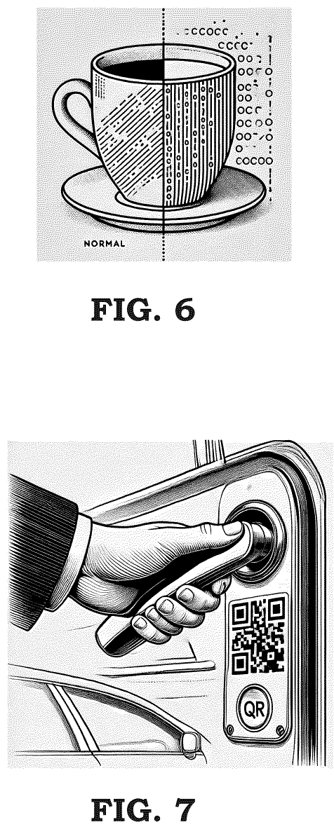

FIG. 6 is a diagram illustrating an embodiment a process of hiding an encoded image in a visible image using a steganographic technique (e.g., object steganography). Steganography refers to the technique of hiding or concealing information or messages within other non-secret data. The goal is to conceal the existence of the information itself. For example, steganography might involve embedding a hidden message within an image or audio file, so that only someone who knows where to look can retrieve the secret data. Thus, steganography is the practice of concealing a message within another medium, making it less obvious that a hidden message exists at all.

For example, a picture may be taken. Then, subtle points are encoded in a way such that it is hidden within the picture. The resulting picture appears to be a copy of the original picture, but it has the encrypted code embedded therein. Thus, a casual observer may not even know the resulting image has a hidden image inside. However, by using a suitable decryption mechanism and knowing the encryption methodology for hiding the second image into the first, the mechanism is able to obtain the encoded image (or message).

Similarly, images may be provided on certain surfaces (e.g., buildings, vehicles, signs, etc.), wherein the images have hidden steganographic images or messages that can be deciphered. The deciphered message, for example, may be a digital certificate or other proof of authenticity. In the field of AR/VR devices, the decoded message can communicate to the AR/VR devices that the object that is within view is a real object and has certain features, characteristics, details, prices, dimensions, manufacturing information, etc. This can be used to validate content with respect to this object to thereby allow the AR/VR device to provide the content to the user with confidence that the content is legitimate.

The strategy of encoding steganographic coded messages or content into images that are associated with various objects in the real world causes the AR/VR device (e.g., AR glasses) to prevent modification of the image or flag any modification to the user (warning). This marking may cause action in the operating system of the AR/VR device for the display device.

A goal of steganography is to hide the fact that communication is taking place. Unlike encryption, which makes a message unreadable to unauthorized parties, steganography aims to make the message invisible. Image steganography (or object steganography) refers to hiding data within the pixels of an image. This can be done by slightly altering pixel values in a way that is imperceptible to the human eye, as shown in FIG. 6. Video steganography refers to concealing messages within video files. Audio steganography refers to embedding information within audio files by modifying certain sound frequencies or by adding noise in a way that does not significantly alter the original audio quality. Text steganography refers to hiding information within text, such as by altering font styles, using specific spacing, or by manipulating certain letters or words. Thus, steganography can be used for security reasons in the field of AR/VR devices to give users confidence that the augmented content that is provided (e.g., on an augmented output layer) is authentic or valid.

### Alternative Encoding Example

FIG. 7 is a diagram illustrating an example of a QR code arranged on the outside surface of a taxicab, taxi, cab, or other vehicle used in a ride-sharing or ride-hailing scenario. When cameras on AR/VR devices are directed toward the QR code, the device may be configured to decode the QR code and obtain validity information to verify that the identity of the vehicle is a valid taxi or ride-sharing vehicle, again giving the user confidence that they are getting into the correct vehicle or into a vehicle that is legitimately registered to provide transportation services.

With respect to the various embodiments described in the present disclosure, it may be noted that laws, rules, regulations, etc. may be enforced in various countries, states, territories, jurisdictions, etc. that the content overlay is validated before it is provided to the user in any form (e.g., visually, audibly, haptically, etc.). Content confirmed to be valid may be used to replace other information that has not been validated. Also, if unconfirmed data has been obtained, the AR/VR devices may be regulated to provide some type of warning to users so that they will know what has been validated and what has not been validated. In addition to regulations, manufacturers of AR/VR device may see a demand by consumers to have such filtering system in the augmentation layer, at least for the purpose of safety (e.g., so as not to drive a car off a bridge or cause other tragedies that occur as a result of the users or operators receiving misleading or incorrect information).

### Operational Examples of AR/VR Devices

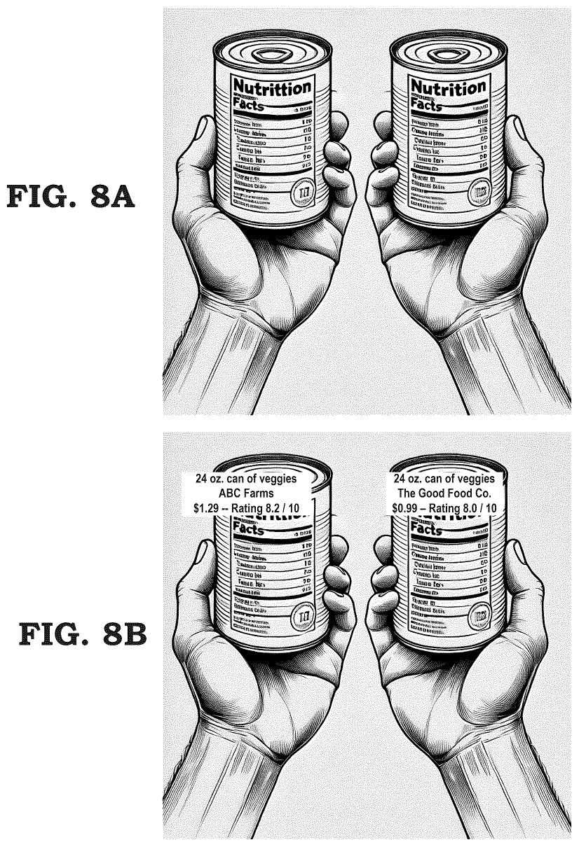

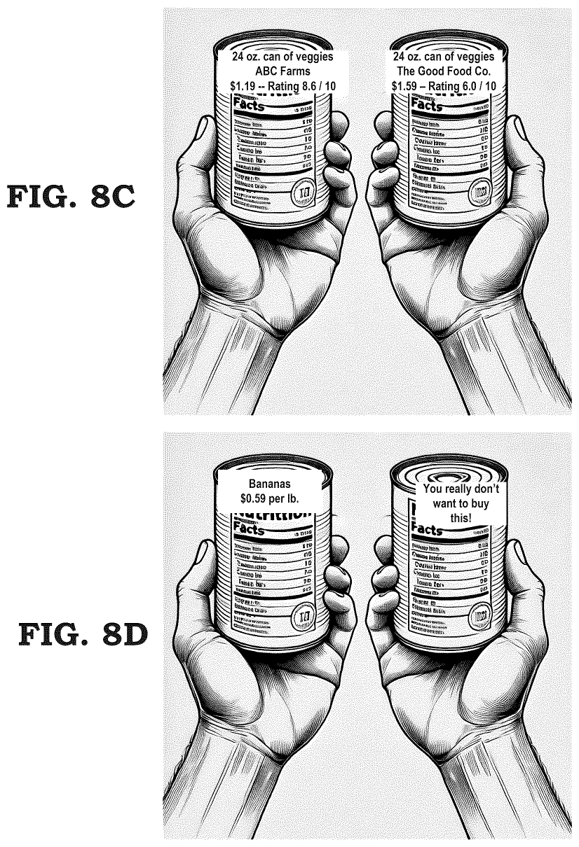

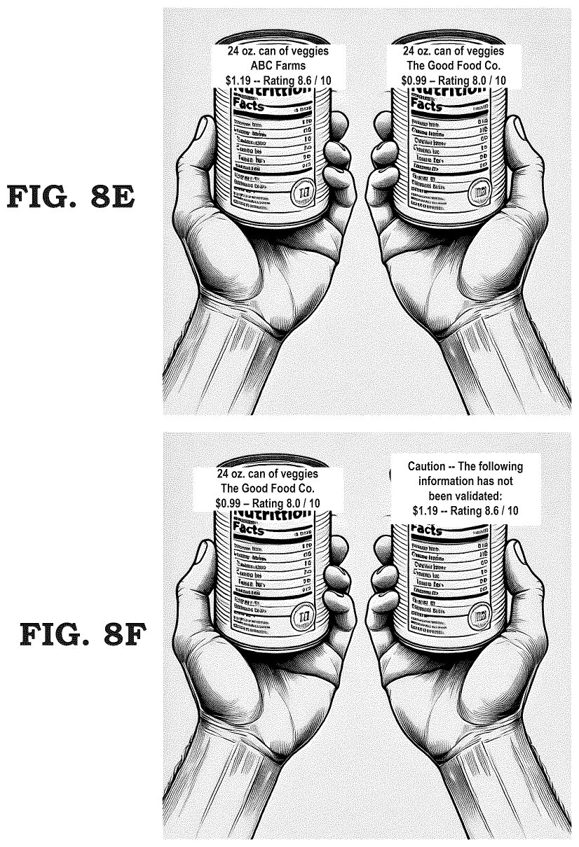

FIGS. 8A-8F are diagrams illustrating examples of content displayed in an augmented content overlay of an AR/VR device. FIG. 8A shows a view of two cans of vegetables that a user can see without the use of an AR/VR device. FIG. 8B shows the cans of vegetables with the use of an AR/VR devices, wherein augmented content is presented in a glass or virtual layer to show information that is valid, legitimate, accurate, etc. and has not been modified. Specifically, FIG. 8B shows real or true information. That is, in this example, the first can is a “24 oz. can of veggies,” produced by “ABC Farms,” has a price of “$1.29,” and has a consumer rating of “8.2 out of 10.” The second can is a “24 oz. can of veggies,” produced by “The Good Food Co. ,” has a price of “$0.99,” and has a consumer rating of “8.0 out of 10.” In this scenario, the consumer may decide on either can after weighing the factors of price, consumer rating, and producer.

FIG. 8C shows an example of tampering or malicious modification of the information that is being fed to the user's AR/VR device. In this example, suppose the culprit of the malicious modification is ABC Farms or is associated with ABC Farms and is trying to persuade the user to choose their product. As shown in FIG. 8C, the price of ABC Farms'product is presented as being lower (i.e., $1.19 instead of the actual price of $1.29) and the competition (i.e., The Good Food Co.) has a price that is presented as being higher (i.e., $1.59 instead of the actual price of $0.99). Also, the consumer ratings are changed to favor the ABC Farms veggies. Without filtering in the augmented content overlay, as described in the various systems and methods of the present disclosure, a consumer may be given the wrong information about these products and will not be able to make an educated decision.

FIG. 8D also shows an example of tampering. However, in this example, the modifications to the augmented content include nonsensical information to confuse the consumer or simply waste their time. For example, the information may be replaced with prices of different products or various comments.

FIGS. 8E and 8F show a couple of examples of the present disclosure, where unvalidated content is flagged. In FIG. 8E, the information for the first can of vegetables cannot be validated or has not yet been validated, while the second can of vegetables may have verifiable content. In this case, the AR/VR device may present the augmented content for the first can in a different font or color (e.g., red) to indicate the unknown nature of the information. For instance, the incorrect information shown in FIG. 8C, which would have been missed by other systems that do not have the content validation filtering of the present disclosure, would be identified as questionable by the present embodiments. Since the content is questionable, the AR/VR devices of the present disclosure can display the unvalidated information in red or highlight the information in some other way (e.g., flashing text, placing an X over the text, etc.). In FIG. 8F, the AR/VR devices of the present disclosure may be configured to provide a warning, such as “Caution—The following information has not been validated . . . ” to flag the user to not accept the information as being real.

The AR/VR devices may include feedback mechanisms that allow the user to receive content in different ways. For example, some users may wish to simply block all content that cannot be validated. Others may wish to receive the content presented in a different manner (FIG. 8E), while others may wish to receive a warning with the content (FIG. 8F).

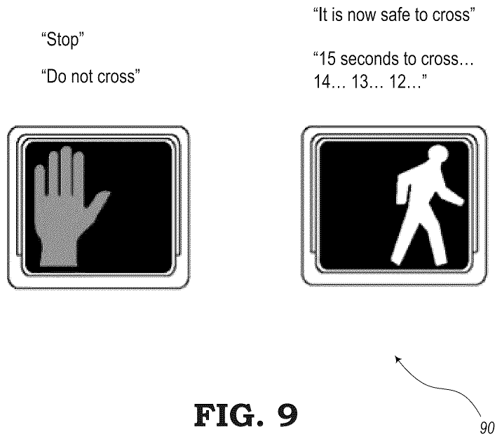

FIG. 9 is a diagram illustrating a pedestrian crossing system 90 where augmented content can be emphasized in a visual and/or auditory manner. In particular, the pedestrian crossing system 90 may be beneficial to individuals who are blind, visually impaired, deaf, hearing impaired, or hard of hearing. For example, the pedestrian crossing system 90 may include a visual component that displays either a hand to indicate “stop” or a person walking to indicate “walk.” Other similar systems may include “Don't Walk” and “Walk” visual instructions. Also, the pedestrian crossing system 90 may include a speaker or other suitable sound producing device for either providing tones or for giving verbal instructions, such as “Stop,”“Do not cross,” “It is now safe to cross,” etc.

The pedestrian crossing system 90 may also be detected visually or audibly by an AR/VR device for assisting a person across the street. Someone who is visually impaired may not be able to see the visual component of the pedestrian crossing system 90 well enough to confidently know when to cross. An AR/VR device may be configured to augment the output of the pedestrian crossing system 90 by presenting validated content to the user, such as by presenting a “stop hand” may visibly and/or increasing the audio of the verbal instructions to “stop.” The benefit of having a filtering mechanism to block malicious or errant information should be clear in this example. Otherwise, without a system that blocks false, fake, misleading, inaccurate, or deceptive content, the visually impaired individual may be put in danger.

### Methods of Operation for Filtering Content

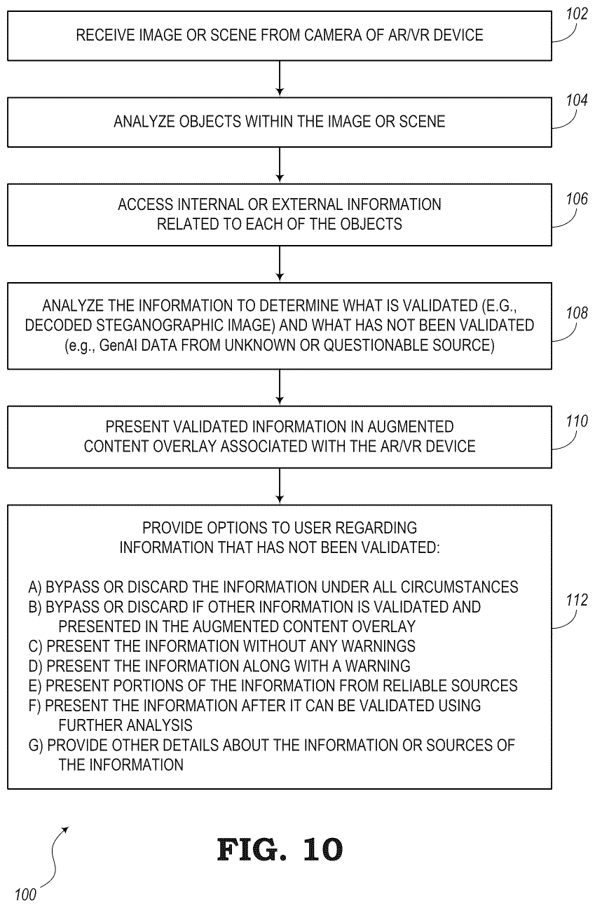

FIG. 10 is a flow diagram illustrating an embodiment of a method 100 for operating an AR/VR device. In this embodiment, the method 100 includes a step of receiving an image or scene from a camera of an AR/VR device, as indicated in block 102. The method 100 further includes a step of analyzing objects within the image or scene, as indicated in block 104. Next, the method 100 includes accessing internal or external information related to each of the objects, as indicated in block 106. This may be done through decoding of steganographic images, QR codes, bar codes, etc., and/or may include retrieving information from various sources (legitimate and/or illegitimate sources) from the Internet.

The method 100 further includes a step of analyzing the information to determine what is validated (e.g., decoded steganographic image) and what has not been validated (e.g., GenAI data from an unknown or questionable source or website), as indicated in block 108. Also, the method 100 includes presenting the validated information in an augmented content overlay (e.g., glass layer) associated with the AR/VR device, as indicated in block 110.

After presenting the valid information, the method 100 includes a step of providing options to the user regarding how to handle information that has not been validated, as indicated in block 112. For example, some options may include a) bypassing or discarding the information under all circumstances, b) bypassing or discarding the information if other information is validated and presented in the augmented content overlay (e.g., as in block 110), c) presenting the information without any warnings (e.g., for those individuals who enjoy being deceived), d) presenting the information along with a warning, e) presenting portions of the information from reliable sources (while blocking information from unreliable sources), f) presenting the information after it can be validated (if ever) using further analysis, g) providing other details about the information or sources of the information, among other options.

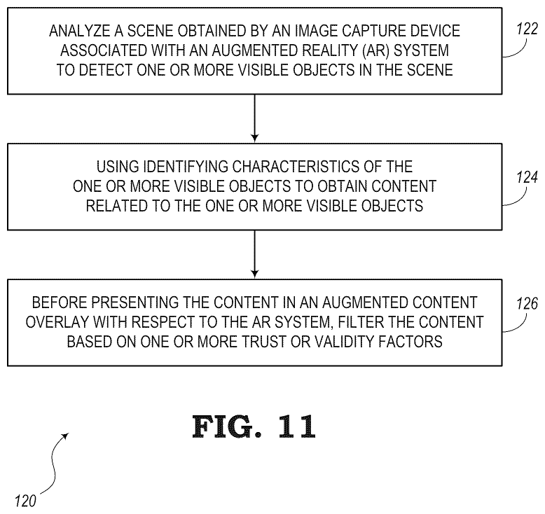

FIG. 11 is a flow diagram illustrating another embodiment of a method 120 for operating an AR/VR device. As shown in this embodiment, the method 120 include analyzing a scene obtained by an image capture device associated with an AR system to detect one or more visible objects in the scene, as indicated in block 122. The method 120 further includes a step of using identifying characteristics of the one or more visible objects to obtain content related to the one or more visible objects, as indicated in block 124. Before presenting the content in an augmented content overlay with respect to the AR system, the method 120 also includes filtering the content based on one or more trust or validity factors, as indicated in block 126.

Furthermore, according to some embodiments, the step of filtering the content may include analyzing the one or more trust or validity factors to determine validity of the content with respect to verifiable content. The verifiable content may include, for example, information decoded from one or more valid steganographic images arranged on the one or more visible objects. In some embodiments, the method may further include a step of presenting the verifiable content in the augmented content overlay and discarding unverified content.

Also, in some implementations, the content may include Generative Artificial Intelligence (GenAI) obtained from one or more internal or external sources, wherein the content may initially be designated as having unknown validity and is considered to be unreliable until the one or more trust or validity factors (block 126) are detected as indicating the validity of the content. The method 120, in some embodiments, may further include a step of presenting options to a user regarding the manner of presentation of the content designated as having unknown validity (e.g., as described in block 112 of the method 100. For example, the method 120 may also include a step of presenting the content designated as having unknown validity with a warning or caution that the content may be unreliable. The method 120 may further include a) performing a source validation procedure to determine the validity of each of the one or more internal or external sources; and b) providing information in the augmented content overlay describing the validity of the one or more internal or external sources.

An action of detecting identifying characteristics (block 124) may include real-time classification and identity functions performed by the AR system itself and/or a cloud-based server. The one or more visible objects, for example, may include street signs, traffic signals, road lane markings, pedestrian crossing signals, lamp posts, utility poles, vehicles, buildings, homes, grocery products, labels, logos, ads, banners, billboards, signs, QR codes associated with objects, bar codes associated with objects, and/or encoded steganographic images configured on specific objects.

In some embodiments, the identifying characteristics of the one or more visible objects (block 124) may include size and shape information, operating status, vehicle make and model information, building address information, ingredient list, decoded optical character recognition information, decoded QR code or bar code information, decoded steganographic information, etc. The method 120 may include presenting the content in the augmented content overlay in a manner that complies with applicable laws and regulations. The step of presenting the content in the augmented content overlay (block 126), for example, may be done in a manner intended to reassure a user of the AR system that the content has been filtered or screened for validity.

### Processing Circuitry and Non-transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. An Augmented Reality or Virtual Reality (AR/VR) system comprising:
an image capture device;
an augmented content overlay configured to present augmented content that appears to a user of the AR/VR system;
a processing device; and
memory configured to store an AR/VR overlay filtering program having computing logic with instructions that, when executed, enable the processing device to perform steps of
analyzing a scene obtained by the image capture device to detect one or more visible objects in the scene,
using identifying characteristics of the one or more visible objects to obtain content related to the one or more visible objects, and
before presenting the content in the augmented content overlay, filtering the content based on one or more trust or validity factors.

2. The AR/VR system of claim 1, wherein the step of filtering the content includes analyzing the one or more trust or validity factors to determine validity of the content with respect to verifiable content.

3. The AR/VR system of claim 2, wherein the verifiable content includes information decoded from one or more valid steganographic images arranged on the one or more visible objects.

4. The AR/VR system of claim 2, wherein the instructions further enable the processing device to present the verifiable content in the augmented content overlay and discard unverified content.

5. The AR/VR system of claim 1, wherein the content includes Generative Artificial Intelligence (GenAI) obtained from one or more internal or external sources, and wherein the content is initially designated as having unknown validity and is considered to be unreliable until the one or more trust or validity factors are detected as indicating the validity of the content.

6. The AR/VR system of claim 5, wherein the instructions further enable the processing device to present options to the user regarding a manner of presentation of the content designated as having unknown validity.

7. The AR/VR system of claim 5, wherein the instructions further enable the processing device to present the content designated as having unknown validity with a warning or caution that the content may be unreliable.

8. The AR/VR system of claim 5, wherein the instructions further enable the processing device to
a) perform a source validation procedure to determine validity of each of the one or more internal or external sources, and
b) provide information in the augmented content overlay describing the validity of the one or more internal or external sources.

9. A method comprising steps of:
analyzing a scene obtained by an image capture device associated with an Augmented Reality (AR) system to detect one or more visible objects in the scene;
using identifying characteristics of the one or more visible objects to obtain content related to the one or more visible objects; and
before presenting the content in an augmented content overlay with respect to the AR system, filtering the content based on one or more trust or validity factors.

10. The method of claim 9, wherein the step of filtering the content includes analyzing the one or more trust or validity factors to determine validity of the content with respect to verifiable content.

11. The method of claim 10, wherein the verifiable content includes information decoded from one or more valid steganographic images arranged on the one or more visible objects.

12. The method of claim 10, further comprising the step of presenting the verifiable content in the augmented content overlay and discarding unverified content.

13. The method of claim 9, wherein the content includes Generative Artificial Intelligence (GenAI) obtained from one or more internal or external sources, and wherein the content is initially designated as having unknown validity and is considered to be unreliable until the one or more trust or validity factors are detected as indicating validity of the content.

14. The method of claim 9, wherein the step of detecting the identifying characteristics includes real-time classification and identity functions performed by one or more of the AR system itself and a cloud-based server.

15. The method of claim 9, wherein the one or more visible objects include one or more of street signs, traffic signals, road lane markings, pedestrian crossing signals, lamp posts, utility poles, vehicles, buildings, homes, grocery products, labels, logos, ads, banners, billboards, signs, QR codes associated with objects, bar codes associated with objects, and encoded steganographic images configured on specific objects.

16. The method of claim 9, wherein the identifying characteristics of the one or more visible objects include one or more of size and shape information, operating status, vehicle make and model information, building address information, ingredient list, decoded optical character recognition information, decoded QR code or bar code information, and decoded steganographic information.

17. The method of claim 9, further comprising the step of presenting the content in the augmented content overlay in a manner that complies with applicable laws and regulations.

18. The method of claim 9, further comprising the step of presenting the content in the augmented content overlay in a manner intended to reassure a user of the AR system that the content has been filtered or screened for validity.

19. A non-transitory computer-readable medium configured to store computing logic having instructions that enable a processing device to:
analyze a scene obtained by an image capture device associated with an Augmented Reality (AR) system to detect one or more visible objects in the scene;
use identifying characteristics of the one or more visible objects to obtain content related to the one or more visible objects; and
before presenting the content in an augmented content overlay with respect to the AR system, filter the content based on one or more trust or validity factors.

20. The non-transitory computer-readable medium of claim 19, wherein the AR system is one of an AR or Virtual Reality (AR/VR) device, smart glasses, smart wearable device, and mobile phone with AR-enabled app.
